(19) United States
(12) Patent Application Publication
(10) Pub. No.: US 2010/0282468 A1
(43) Pub. Date: Nov. 11, 2010

(54) FRACTURING FLUID COMPOSITIONS COMPRISING SOLID EPOXY PARTICLES AND METHODS OF USE

(76) Inventors: Dean Michael Willberg, Salt Lake City, UT (US); James G. Carlson, Lake Elmo, MN (US); Ignatius A. Kadoma, Cottage Grove, MN (US); Yong K. Wu, Woodbury, MN (US); Michael D. Crandall, North Oaks, MN (US)

Correspondence Address: MUETING, RAASCH & GEBHARDT, P.A., P.O. BOX 581336, MINNEAPOLIS, MN, 55458-1336, US

(21) Appl. No.: 12/808,117

(22) PCT Filed: Dec. 5, 2008
(86) PCT No.: PCT/US08/85665

§ 371 Date: Jun. 14, 2010

Related U.S. Application Data
(60) Provisional application No. 61/014,001, filed on Dec. 14, 2007.

(51) Int. Cl. E21B 43/16; C09K 8/68

(52) U.S. Cl. 166/305.1; 507/219

(57) ABSTRACT

Fluid compositions and methods of making and using same are described, the fluid compositions comprising at least one solid epoxy particle, at least one epoxy resin curing agent, and at least one type of proppant particles. The methods comprise deploying a fluid composition into a wellbore extending to a subterranean geological formation using pressure sufficient to form a fracture in the subterranean geological formation, and immobilizing at least a portion of the solid epoxy particles and proppant particles in the fracture. Embodiments of the fluid compositions are useful for increasing hydrocarbon production from subterranean geologic formations, and/or controlling solids migration in such formations.

### BACKGROUND

Fracturing is a well stimulation technique designed to increase the productivity of a well, such as a hydrocarbon oil or gas well, by creating highly conductive fractures or channels in the producing geologic formation around the well. One approach is hydraulic fracturing, a process that involves injecting a fluid at a high rate and high pressure to rupture the formation and create cracks in the rock and pumping into these cracks a fluid containing a particulate material (propping agent or proppant) to maintain the cracks or fractures open by resisting the forces which tend to close the fractures. Thus, the function of the proppant is to provide high permeability in the propped fracture. Hydraulic fracturing has been used with increasing frequency to improve the productivity of gas and oil wells in low permeability reservoirs. Another approach for forming and propping highly conductive fractures utilizes an etching solution such as the acid etching process.

Although there are a number of fracturing fluids known in the art, there is a continuing desire for additional fracturing fluids, in particular those with improved proppant binding.

### SUMMARY

In one aspect, the present disclosure describes a fluid composition comprising solid epoxy particles, epoxy resin curing agent, proppant, and well-bore fluid (e.g., comprising at least fracturing fluid). As used herein the term “solid” means “non-liquid” and “non-coated.” In some embodiments, the average particle size of the solid epoxy particles is less than the average size of the proppant. In some embodiments, the solid epoxy particles have an average particle size up to about 3500 micrometers (in some embodiments, in a range from about 20 micrometers to about 3500 micrometers, about 50 micrometers to about 1000 micrometers, or about 100 micrometers to about 500 micrometers), and wherein the proppant have an average particle size up to about 3500 micrometers (in some embodiments, in a range from about 100 micrometers to about 3500 micrometers, about 250 micrometers to about 2000 micrometers, or about 500 micrometers to about 1000 micrometers). In some embodiments, the solid epoxy particles and the proppant each have an average particle size, and wherein the average particle size of the proppant is within 50 percent (in some embodiments, within 60, 70, 80, 85, 95, 100, 105, 110, 120, 130, 140, or even within 150 percent) of the average particle size of the solid epoxy particles. In some embodiments, a portion of the solid epoxy particles are adhered to at least some of the proppant particles. As used herein, “solid epoxy particles” refer to particles comprising at least 5% by volume cured plus uncured epoxy resin, wherein the balance, if any, may comprise uncured monomer, filler, water, organic solvent, and the like, and has at least one softening point in a range from 50° C. to 200° C. In some embodiments, the solid epoxy particles comprise at least 10%, 15%, 20%, 25%, 30%, 35%, 40%, 45%, 50%, 55%, 60%, 65%, 70%, 75%, 95%, 99%, or even 100% by volume cured plus uncured epoxy resin. Solid epoxy particles are not intended to comprise any solid particles of any size or shape that could themselves be effective to sustain fractures in an open position. In some embodiments, the solid epoxy particle has a softening point of at least about 40° C. (in some embodiments, from about 40° C. to about 150° C., about 50° C. to about 120° C., about 60° C. to about 120° C., or about 70° C. to about 110° C.) as measured by ASTM D3104-99 (1999), the disclosure of which is incorporated herein by reference. In some embodiments, the epoxy particles comprise an epoxy curing agent. In some embodiments, the cure temperature of about 50° C. to about 200° C. (in some embodiments, from about 75° C. to about 150° C., or about 100° C. to about 130° C.).

As used herein the term “fluid composition” means a flowable composition; or a composition that is capable of being made flowable upon change of one or more conditions, such as shear, temperature change, pH change, and the like.

In some embodiments, the solid epoxy particles include first solid epoxy particles comprising first epoxy resin and second solid epoxy particles comprising second, different epoxy resin, wherein, in some embodiments, the epoxy resin curing agent includes at least two different epoxy resin curing agents. In some embodiments, at least some of the solid epoxy particles comprise at least two different epoxy resins, wherein, in some embodiments, the epoxy resin curing agent includes at least two different epoxy resin curing agents. In some embodiments, at least some of the curing agent is present in at least some of the solid epoxy particles. In some embodiments, at least a portion of the solid epoxy particles and curing agent are present in a composite and which optionally contain fillers such as talc, clay, barium sulfate, silica and the like (e.g., in the form of a particle, flake, needle, wedge, sphere, rectangle, polyhedron, pellet, donut, ribbon, and the like, or mixtures thereof).

The present disclosure describes a method of making a fluid composition described herein, the method comprising combining at least solid epoxy particles dispersed in a fluid, epoxy resin curing agent, proppant, and well-bore fluid. The present disclosure also describes a method of making a fluid composition described herein, the method comprising combining at least solid epoxy particles dispersed in a fluid, the dispersion further comprising the curing agent, proppant, and well-bore fluid. In some embodiments of these methods, the curing agent is separate from the epoxy resin.

The present disclosure describes a subterranean formation having a surface in contact with a fluid composition described herein. The present disclosure also describes a method of treating a subterranean formation, the method comprising deploying a fluid composition described herein into a wellbore such that at least a portion of the fluid composition is in contact with at least one surface of the subterranean formation. In some embodiments, deploying comprises exposing the solid epoxy particles to a temperature in a range from about 50° C. to about 200° C., wherein, in some embodiment, exposing the solid epoxy particles to a temperature in a range from about 50° C. to about 200° C. comprises providing a heated fluid in the wellbore. In some embodiment, the exposing comprises flushing the solid epoxy particles and proppant particles in the fracture with an after wash solution. In some embodiments, the method further comprises exposing the solid epoxy particles and proppant particles in the fracture to conditions sufficient to trigger the latent epoxy resin curing agent to cure substantially all of any remaining uncured epoxy resin. In some embodiments, the solid epoxy particles comprise first solid epoxy particles comprising a first epoxy resin and second solid epoxy particles comprising a second, different epoxy resin, the method further comprising exposing the composition to conditions sufficient to cure the first epoxy resin to form a first cured composition, and subsequently exposing the first cured composition to conditions sufficient to cure the second epoxy resin to form a second cured composition. In some embodiments of this method, the subterranean formation has a temperature, the method further comprising making the fluid composition by at least:
determining the temperature of the subterranean formation;
generating, based at least in part on the determined temperature of the subterranean formation, a fluid composition design, wherein the designed fluid composition comprises the solid epoxy particles, the epoxy resin curing agent, the proppant, and the well-bore fluid, the solid epoxy particles having at least one softening point less than the temperature of the subterranean formation, and the solid epoxy particles together with the curing agent having a cure temperature less than the temperature of the subterranean formation; and
making the designed fluid composition.

The present disclosure describes a method of propping open fractures in the walls of a bored well, the method comprising:
deploying the fluid composition described herein, wherein the well-bore fluid comprises fracturing fluid, into a wellbore at a pressure sufficient to create fractures in a subterranean formation, wherein the fracturing fluid flows into the fractures, and wherein at least the proppant prop open at least some of the fractures.

The present disclosure describes a method of making a fluid composition, the method comprising:
selecting a subterranean formation having a temperature;
determining the temperature of the subterranean formation;
generating, based at least in part on the determined temperature of the subterranean formation, a fluid composition design, wherein the design fluid composition comprises solid epoxy particles, epoxy resin curing agent, proppant, and well-bore fluid, the solid epoxy particles having at least one softening point less than the temperature of the subterranean formation, and the solid epoxy particles together with the curing agent having a cure temperature less than the temperature of the subterranean formation; and
making the designed fluid composition.

The various aspects of the invention will become more apparent upon review of the brief description of the drawings, the detailed description of the invention, and the claims that follow.

### BRIEF DESCRIPTION OF THE DRAWINGS

For a more complete understanding of the features and advantages of the present invention, reference is now made to the detailed description of the invention along with the accompanying figures and in which:

FIGS. 1, 2, and 3 are schematic illustrations of three embodiments of compositions described herein.

### DETAILED DESCRIPTION

In the following description, numerous details are set forth to provide an understanding of the present invention. However, it will be understood by those skilled in the art that the present invention may be practiced without these details and that numerous variations or modifications from the described embodiments may be possible.

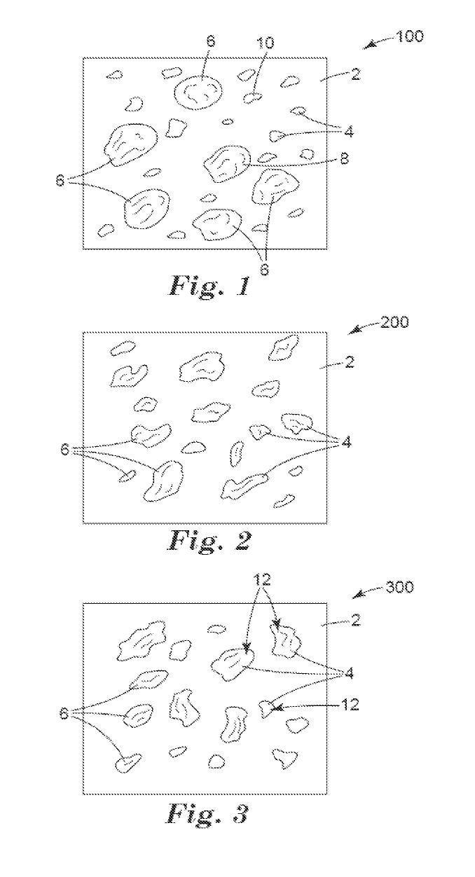

FIGS. 1, 2, and 3 are schematic illustrations of three embodiments 100, 200 and 300 of compositions within the invention. FIG. 1 illustrates a fluid composition 100 comprising well-bore fluid 2, solid epoxy particles 4 including epoxy resin curing agent (not illustrated in this figure), and proppant 6. FIG. 1 also illustrates a second proppant particle 8 of a different composition than proppant 6, as well as second solid epoxy particle 10 different in composition compared to solid epoxy particles 4. The embodiment illustrated in FIG. 1 has the proppant particles 6, 8 generally larger than the solid epoxy particles 4, 10.

FIG. 2 is similar to FIG. 1 but illustrates an embodiment 200 where the average particle sizes of the solid epoxy 4 and proppant 6 are substantially equal. FIG. 3 illustrates an embodiment 300 which is the reverse of embodiment 100, having the solid epoxy particles 4 generally larger than the proppant particles 6. The embodiment of FIG. 3 also illustrates epoxy resin curing agent 12.

The solid epoxy particles can be made, for example, from diglycidyl ethers of aromatic bisphenols that have been advanced in molecular weight by reaction with aromatic bisphenols, phenolic novolaks, and combinations thereof. In some embodiments, the solid epoxy particles comprise at least one epoxy resin selected from the group consisting of diglycidyl ethers of bisphenol A, diglycidyl ethers of bisphenol F, novolak epoxy, and combinations thereof.

Suitable epoxy curing agents include various aromatic bisphenols, dicyandiamide, anhydrides and amines. In some embodiments, the epoxy curing agents are incorporated into the solid epoxy particles, and/or provided externally to the particles through methods known to the art.

Examples of the preparation of epoxy resins and the preparation of solid epoxy particles containing epoxy curatives and other additives are given, for example, in U.S. Pat. No. 5,407,978 (Bymark et al.), the disclosure of which is incorporated herein by reference.

Useful solid epoxy particles may take the form of spheres, spheroids, rods, pellets, tablets, flakes, powders, and other shapes. The solid epoxy particles need not be the same size and shape, or even have the same epoxy resin and curing agents.

Optionally, the cure temperature can be formulated to be appropriate to different geological formation conditions through choice of curing agents and accelerators.

Suitable epoxy resin curing agents may be organic, inorganic, and combinations (mixtures) of organic and inorganic molecules. Exemplary epoxy curing agents may be organic molecules or mixtures of organic molecules, wherein the molecules or mixture thereof may be selected on-site or near the wellbore site to provide an optimum cure rate of the epoxy resin as dictated by the wellbore temperature, pressure, and shear conditions, as well as the epoxy resin chemistry. Typically, solid epoxy particles suitable for use in the compositions disclosed herein function to adhere to surfaces present in a well fracture (e.g., proppant particles and fracture rock).

Solid epoxy resin particles useful in the invention may comprise heat-curable powder epoxy resin compositions, which can be prepared from a epoxy resin containing curatives and optionally fillers, pigments, cure accelerators, flow control agents and the like. Some suitable solid epoxy particles are commercially available in the form of epoxy powders sold, for example, under the trade designations “SCOTCHCAST” and “SCOTCHKOTE” by the 3M Company, St. Paul, Minn.

The solid particles may further comprise curing accelerators, advancement agents, fillers, pigments, flow control agents and the like. At least a portion of the solid epoxy resin particle contains unreacted epoxy groups, which may be cured upon interaction with one or more epoxy resin curing agents after the composition is deployed downhole in a well treatment operation and experiences sufficient heat.

In some embodiments described herein, the solid epoxy particles may be dispersed in an aqueous solution along with some or all of the curing agents(s) to form an aqueous dispersion, which is in turn mixed with proppants and a well-bore fluid. Surfactants, dispersants, or other additives may be used to promote dispersibility of the solid epoxy particles in the well-bore fluid. An exemplary commercially available aqueous water-based epoxy resin dispersion is sold by Air Products, Allentown, Pa., under the trade designation name “ANCAREZ”.

In some embodiments, the epoxy resin curing agent may be termed a “latent” curing agent, meaning that it does not cure in the epoxy resin in the solid epoxy particles until reaching expected or desired temperature, pressure, and shear conditions. The epoxy resin curing agent may be solid, liquid, or combination thereof, such as beads impregnated with the curing agent. Organic epoxy resin curing agents may be acid functionalized or base functionalized.

Epoxy resin curing agents function to cure the solid epoxy resins through the oxirane rings. Cure may take place through addition of a polyfunctional curing agent to an oxirane ring or through homopolymerization of the oxirane rings. Epoxy curing agents also function as a design tool, allowing for tuning of the inventive compositions so that they are suitable for a variety of downhole conditions. Epoxy resin curing agents suitable for use in the compositions disclosed herein include so-called slow curing agents, fast curing agents, and latent curing agents, which may be fast curing after a certain trigger temperature is reached, but slow or non-reactive at temperatures below the trigger temperature. By using combinations of slow and fast curing agents, or latent curing agents, one may design curing agents that partially cure the epoxy resin in the solid epoxy particles at a first temperature, and as temperature increases, fully cure the epoxy resin.

Proppants useful in the composition disclosed herein include previously known proppants, such as naturally occurring sand grains, ground fruit pits, ground nut shells, composite materials, other engineered proppants, such as resin-coated sand or high-strength ceramic materials like sintered bauxite, and the like.

Suitable proppants include those comprising a material selected from sand, ceramic (i.e., glass, crystalline ceramic, glass-ceramic, and combinations thereof) beads, glass microspheres, synthetic organic beads, resin coated proppant, and sintered minerals (e.g., sintered alumina, sintered bauxite, and the like). Other materials may used, such as nut shells, aluminum, aluminum alloys, wood (e.g., wood chips), coke (e.g., crushed coke), slag (e.g., granulated slag), coal (e.g., pulverized coal), rock (e.g., crushed rock), metal (e.g., granules of steel), refractories (e.g., mullite), flint, garnet, diamond, silicon carbide, and the like. The proppant may be in any of a variety of shapes and sizes. The desired size and shape may depend, for example, on factors such as the proppant core material, the well fractures to be propped, the equipment to be used to inject the proppant articles into the well, and the carrier fluid used. For example, in some embodiments of the proppant cores may have a sphericity of less than about 0.9 (in some embodiments, less than about 0.7), as measured according to American Petroleum Institute Method RP56, “Recommended Practices for Testing Sand Used in Hydraulic Fracturing Operations”, Section 5, (Second Ed., 1995) (referred to herein as “API RP 56”).

Exemplary proppant will meet or exceed the standards for sphericity, roundness, size, turbidity, acid solubility, percentage of fines, and crush resistance as recited in API RP 56 for proppant. The API RP's describe the minimum standard for sphericity as at least 0.6 and for roundness as at least 0.6. As used herein, the terms “sphericity” and “roundness” are defined as described in the API RP's and can be determined using the procedures set forth in the API RP's. API RP 56 also sets forth some commonly recognized proppant sizes as 6/12, 8/16, 12/20, 20/40, 30/50, 40/70, and 70/140. The API RP's further note that a minimum percentage of particulates that should fall between designated sand sizes, noting that not more than 0.1 weight % of the particulates should be larger than the larger sand size and not more than a maximum percentage (1 weight % in API RP 56 and 2 weight % in API RP 58) should be smaller than the small sand size. Thus, for 20/40 proppant, no more than 0.1 weight % should be larger than 20 U.S. Mesh and no more than 1 weight smaller than 40 U.S. Mesh. API RP 56 describes the minimum standard for proppant turbidity as 250 FTU or less. API RP 56 describes the minimum standard for acid solubility of proppant as no more than 2 weight % loss when tested according to API RP 56 procedures for proppant sized between 6/12 Mesh and 30/50 Mesh, U.S. Sieve Series and as no more than 3 weight % loss when tested according to API RP 56 procedures for proppant sized between 40/70 Mesh and 70/140 Mesh, U.S. Sieve Series. API RP 56 describes the minimum standard for crush resistance of proppant as producing not more than the suggested maximum fines as set forth in Table 1 for the size being tested.

TABLE 1
Suggested Maximum Fines of Proppant
Subjected to Crushing Strength

| Mesh Size | | Stress on | |
|---|---|---|---|
| (U.S. Sieve | Crushing Force | Proppant | Maximum Fines |
| Series) | (lbs)[kg] | (psi)[MPa] | (% by weight) |
| 6/12 | 6,283 [2,850] | 2,000 [13.8] | 20 |
| 8/16 | 6,283 [2,850] | 2,000 [13.8] | 18 |
| 12/20 | 9,425 [4,275] | 3,000 [20.7] | 16 |
| 16/30 | 9,425 [4,275] | 3,000 [20.7] | 14 |
| 20/40 | 12,566 [5,700] | 4,000 [27.6] | 14 |
| 30/50 | 12,566 [5,700] | 4,000 [27.6] | 10 |
| 40/70 | 15,708 [7,125] | 5,000 [34.5] | 8 |
| 70/140 | 15,708 [7,125] | 5,000 [34.5] | 6 |

Proppant useful in the invention may range in size (largest dimension) from about 50 micrometers to about 5000 micrometers (in some embodiments from about 100 micrometers to about 3500 micrometers, or even from 400 micrometers to about 1000 micrometers). Proppant may be any shape, including spherical, hemi-spherical, pyramidal, rectangular (including cubed), cylindrical, tablet-shaped, pellet-shaped, and the like.

The size and distribution of the proppant may chosen to fit the characteristics of the well being propped. In some embodiments, the proppant have unimodal size distribution, while in other embodiments, at least a bimodal distribution; in some embodiments, at least a trimodal distribution.

Other suitable proppants are the those described in assignee's U.S. Provisional Patent Application having Ser. No. 61/013,998 (Attorney Docket No. 63015US002; entitled “Proppants and Uses Thereof”), filed the same date as the instant application, the disclosure of which is incorporated herein by reference.

In some embodiments, the fluid composition comprises, by weight, 0.5 to 10 percent solid epoxy particles, 35 to 50 percent proppants, and 40 to 65 percent well-bore fluid, the based on the total weight of the composition. The weight ratio of epoxy resin to epoxy resin curing agent present in the solid epoxy particles may range, for example, from about 1:1 to about 1:100. In some embodiments, the size of the solid epoxy particles and proppant is the same or generally about the same.

Fluid compositions can be designed, for example, by obtaining or at least estimating, downhole conditions of temperature, pressure, fracture size desired. Based on at least on these values, the composition of the solid epoxy particles, epoxy resin curing agent(s), proppants, and fracturing fluid may be matched with the downhole conditions expected for the composition.

In some embodiments, the solid epoxy particles may be dispersed in an aqueous solution along with some or all of the curing agents(s) to form a aqueous dispersion, and then this dispersion is mixed with proppants and a hydraulic fracturing fluid.

Methods of making fluid compositions described herein include a method comprising selecting a geological formation comprising hydrocarbons having a temperature, and determining the temperature of the geological formation comprising hydrocarbons. Based at least in part on this knowledge, generating a fluid composition design, wherein the fluid composition comprises solid epoxy particles, an epoxy resin curing agent, proppants, and hydraulic fracturing fluid, the solid epoxy particles having at least one melting point less than the temperature of the geological formation comprising hydrocarbons, and the solid epoxy particles together with the curing agent have a cure temperature less than the temperature of the geological formation comprising hydrocarbons. The designed fluid composition may then be manufactured or selected from an assortment of available, in stock, fluid compositions.

In methods of propping open fractures in the walls of a wellbore using a fluid composition described herein, one then provides a fluid composition described herein. The fluid composition, or more than one in sequence, if necessary, is then injected into the wellbore at a pressure sufficient to create fractures in the subterranean formation, wherein the fracturing fluid flows into the fractures. By exposing the solid epoxy particles and epoxy resin curing agent to downhole conditions, either the epoxy resin and curing agent will cure, or an after wash solution may need to be applied downhole, comprising for example an acid or a base, which may be organic, inorganic, or mixture thereof. In both situations, a 2- or 3-dimensional network comprising the proppant and at least partially cured solid epoxy particles will form in at least some of the fractures, aiding in proppant and fines flowback control. Exemplary methods in accordance with the present disclosure comprise reducing proppant flowback from the percentage of fractures filled with the network. The percentage may range, for example, from 10 percent to 100 percent. Subsequently, through change of conditions, the mass may become porous, or more porous than when cured, aiding in production of hydrocarbons from the geologic formation. The change of conditions may occur through operator intervention, for example by circulating a heated fluid having sufficient heat to melt or partially melt the cured epoxy resin.

Commonly, a fracturing fluid is used to initiate and propagate fractures and to transport a proppant to hold the walls of the fracture apart after the pumping has stopped and the fracturing fluid has leaked off or flowed back. Many known fracturing fluids comprise a water-based carrier fluid, a viscosifying agent, and the proppant. The viscosifying agent is often a cross-linked water-soluble polymer. As the polymer undergoes hydration and crosslinking, the viscosity of the fluid increases and allows the fluid to initiate the fracture and to carry the proppant. Another class of viscosifying agent is viscoelastic surfactants (“VES's”). Both classes of fracturing fluids (water with polymer, and water with VES) can be pumped as foams or as neat fluids (i.e., fluids having no gas dispersed in the liquid phase). Foamed fracturing fluids typically contain nitrogen, carbon dioxide, or mixtures thereof at volume fractions ranging from 10% to 90% of the total fracturing fluid volume. The term “fracturing fluid,” as used herein, refers to both foamed fluids and neat fluids. Non-aqueous fracturing fluids may be used as well.

The well-bore (e.g., hydraulic fracturing fluid) used in fluid compositions described herein may be the same fluid that is used in a typical fracturing operation, and may be water-based, oil-based, emulsified, and the like as known in the art. As used herein, the term “introducing” (and its variants “introduced”, etc.) includes pumping, injecting, pouring, releasing, displacing, spotting, circulating, or otherwise placing a fluid or material within a well, wellbore, fracture or subterranean formation using any suitable manner known in the art.

A variety of aqueous and non-aqueous well-bore fluids may be used in the present invention. Illustrative examples of water-based fluids and brines which are suitable for use with the fluid compositions described herein include fresh water, sea water, sodium chloride brines, calcium chloride brines, potassium chloride brines, sodium bromide brines, calcium bromide brines, potassium bromide brines, zinc bromide brines, ammonium chloride brines, tetramethyl ammonium chloride brines, sodium formate brines, potassium formate brines, cesium formate brines, and combinations thereof.

Examples of water-based polymer and polymer-containing treatment fluids suitable for use with the present invention include any such fluids that can be mixed with the previously mentioned water-based fluids. Specific water-based polymer and polymer-containing treatment fluids for use with the fluid compositions described herein include guar and guar derivatives (e.g., hydroxypropyl guar (HPG), carboxymethylhydroxypropyl guar (CMHPG), carboxymethyl guar (CMG), hydroxyethyl cellulose (NEC), carboxymethylhydroxyethyl cellulose (CMHEC), carboxymethyl cellulose (CMC), starch-based polymers, xanthan based polymers, and biopolymers (e.g., gum Arabic, carrageenan, and the like), as well as any combination of the above-mentioned fluids.

Examples of non-aqueous treatment fluids suitable for use in fluid compositions described herein include alcohols (e.g., methanol, ethanol, isopropanol, and other branched and linear alkyl alcohols); diesel; raw crude oils; condensates of raw crude oils; refined hydrocarbons such as gasoline, naphthalenes, xylenes, toluene and toluene derivatives, hexanes, pentanes, and ligroin; natural gas liquids, gases such as carbon dioxide and nitrogen gas, and combinations of any of the above-described non-aqueous treatment fluids. Alternatively, mixtures of the above non-aqueous fluids with water are also envisioned to be suitable for use with the present invention, such as mixtures of water and alcohol or several alcohols. Mixtures can be made of miscible or immiscible fluids.

Fluid compositions described herein may include at least one breaker material. In this regard, any suitable breaker known in the well treating art may be employed in a polymer treatment fluid. Examples of suitable breaker materials include enzymes and/or one or more oxidative breakers known in the well treating industry. Specific examples of suitable oxidative breakers include encapsulated breakers, such as encapsulated ammonium persulfate (e.g., those marketed by Schlumberger, Sugar Land, Tex. under the trade designations “EB-CLEAN”). Other suitable breakers which may be employed in a polymer treatment fluid include conventional oxidative breakers, such as ammonium peroxydisulfate. Typically, such breakers are included in a polymer treatment fluid in a concentration of between about 0.1 lb/1000 gals (10.3 g/m³) and about 10 lb/100 gals (1031.8 g/m³). Most typically a conventional oxidative breaker is employed with an enzyme pre-treatment fluid comprising a polymer specific enzyme. The second fluid can also be heavily laden with breakers, water and/or scale control additives, paraffin control additives or other chemical components.

Solid epoxy particles, epoxy curing agent, and proppants may be mixed with a fracturing fluid and introduced into a well having side wall fractures which are desired to be propped open to enhance transmission of subject fluids there through. The fracturing fluid carries the solid epoxy particles, curing agent, and proppant into the fractures where they are deposited. If desired, the proppants or the epoxy particles might be color coded and injected in desired sequence such that during transmission of subject fluid there through, the extracted fluid can be monitored for presence of the proppant. The presence and quantity of different colored proppants might be used as an indicator of what portion of the fractures are involved as well as indicate or presage possible changes in transmission properties.

Compositions and methods of the invention may be used in wells to enhance extraction of desired fluids (i.e., subject fluids) such as oil, natural gas, or water, from naturally occurring or man-made reservoirs, and may also be used in wells to enhance injection of desired fluids into naturally occurring or man-made reservoirs.

Optionally, other materials may be combined with the fluid compositions described herein, including surfactants, rheological modifiers, tackifiers, fillers, fibers, salts, and other proppants. In some embodiments of fluid compositions described herein, the epoxy resin may be tacky, or designed to have latent tackiness (i.e., tack can be increased by exposure to one or more conditions during or after deployment through a wellbore, such as by release of or inclusions of a modifier, in which case the modifier may be termed a tackifier). The tack properties of epoxy resins useful in the fluid compositions described herein may be controlled by temperature, by the addition of a chemical which chemically modifies the polymer, by the addition of a tackifier, or combination of these.

Suitable tackifiers may be selected from organic materials having a T_{g} of no less than about 120° C., in some embodiments having a T_{g} no less than about 150° C., and may be present in a tackifier composition comprising a naphthenic oil diluent present in sufficient amount to give the tackifier a kinematic viscosity ranging from about 3,000 to about 5,000 centistokes at 100° C. The tackifier may be present at about 0.5 to about 2.0 weight percent of the total weight of the tackifier composition. Suitable tackifiers include organic material is selected from polyalkylene resins and polycycloalkene resins, wherein the polyalkylene resin may be selected from polybutene resins, dipentene resins, and terpolymers of ethene, 1-propene, and 1,4-hexadiene. Suitable polycycloalkene resins include phenol-aldehyde resins, terpene resins, rosins, polyethylene rosin esters, phenolic polyterpene resins, limonene resins, and pinene resins. Other suitable tackifiers include terpolymers of ethene, 1-propene, and 1,4-hexadiene. Suitable adhesion agents include silicone oils, for example the organosiloxane silicone oils known under the trade designations “TEGOSIVIN” HL15M7 and “TEGOSIVIN” HL100, both available from Goldschmidt Chemical, Hopewell, Va.

Optionally, an adhesion agent may be included in the tackifier composition, and if so may be present at about 0.5 to about 5 weight percent of the total weight of the tackifier composition, with the balance being an organic oil. Suitable organic oils include mineral oils, for example slate oil, rock oil, coal oil, and seneca oil. If compatible, these materials may be used (combined with) the materials used in the proppant core coatings.

The addition of fibers in intimate mixtures with particulates for fracturing and gravel packing decreases or eliminates the undesirable flowback of proppant or formation fines while stabilizing the sand pack and lowering the demand for high polymer loadings in the placement fluids. Fibers are useful for forming a porous pack in the subterranean formation. In some cases, channels or fingers of void spaces with reduced concentrations of proppant may be introduced into the proppant pack. Additional details on incorporating fibers in fluid compositions can be found, for example in U.S. Pat. Nos. 5,330,005 (Card et al.); 5,439,055 (Card et al.); 5,501,275 (Card et al.); and 6,172,011 (Card et al.), the disclosures of which are incorporated herein by reference.

Rheological modifiers may be added to fluid compositions when desired, for example to increase the elastic modulus, which in turn increases the shear strength, friction pressure, or other flow characteristics of the fluid. Exemplary rheological modifiers may include water-based polymers previously mentioned as suitable for use as treatment fluids, such as guar and guar derivatives, cellulose and cellulose derivatives, polyacrylamides, polyacrylates, starch based polymers, xanthan based polymers, and biopolymers such as gum Arabic, carrageenan, and the like, as well as any combination of the above-mentioned fluids. Typically, the amount and type of rheological modifier used depends on the chemistry of the carrier fluid, and the intended end use of the fluid composition. Generally, a sufficient amount of rheological modifier is used to increase in the elastic modulus and shear strength as desired. Typically, not more than 10% by weight (in some embodiments, not more than 5 or even not more than 1% by weight) of the fluid composition comprises the rheological modifier.

Fluid compositions may be mixed or blended using any number of conventional mixing or blending systems and pumped into the well from the surface using any of a number of conventional pumping systems. Mixing or blending systems may include liquid or dry additive systems, as well as a proppant additive system or systems. If desired, the solid epoxy particles or the epoxy curing agent, or both, may be provided to the fluid composition at the mixer or blender system via one or more additive system.

The following examples are provided to illustrate some embodiments of the invention and are not intended to limit the scope of the claims. All percentages are by weight unless otherwise noted.

### Example

### Epoxy Additive

A. Proppant Flowback Stability Measurements

The proppant flowback stability measurements were performed in an apparatus consisting of the following assemblies: 1) a flowback cell which contained the sand or proppant pack being tested, 2) a circulation system which pumped water through the proppant pack in the cell, and 3) a hydraulic press that applied a uniaxial closure stress onto the proppant pack. The flowback cell consisted of a rectangular body that had an interior 5.25 in.×5.25 in. (13.3 cm×13.3 cm) working area which held the proppant pack. After the cell was filled with the proppant, sand and flowback agent (if any) a square piston was inserted into the body on top of the proppant pack. Water was pumped through the rectangular proppant pack from an upstream inlet side through to the discharge side. On the upstream side of the cell, there were three 13 mm inlets for the inflow of water. On the discharge side of the cell there was a 10 mm outlet that represented a perforation. That is, the sandpack was free to move if it had insufficient strength to withstand the stresses generated by the flow of water. After the flowback cell was filled and assembled, it was placed in the hydraulic press which then applied the designated closure stress to the proppant pack. The system was equipped with computer control and data acquisition to measure pack width, flow rate and upstream pressure.

The proppant flowback stability measurements were performed on a sand pack made from pure fracturing sand of 20/40 mesh (API RP 56) obtained from Badger Mining Corporation, Berlin, Wis. and the flowback control additives. The total mass of the solids in the pack (sand plus flowback control additives) was set at 400 grams. The uniaxial closure stress was set to 4000 psi (27.6 MPa), and the tests were performed at 95° C. At the start of each test the flow rate of water was zero. As the test progressed the flow rate of water was continuously increased at a rate of 4 L/min.2 till pack failure was observed or until the pressure drop across the proppant pack in the cell was 25 bar (2.5 MPa). The flow rate at the pack failure was used as a characteristic of the flowback stability of the proppant pack.

B. Sample Preparation and Flowback Performance

A mixture of 400 grams of pure fracturing sand of 20/40 mesh (API RP 56) obtained from Badger Mining Corporation, Berlin, Wis. and a single-component white epoxy powder known by the trade designation “SCOTCHCAST 265”, from 3M Company, St. Paul, Minn. (4 weight % of the proppant) was placed into the cell. A cell was filled by 2% KCl and installed into the press for 20 hr at 95° C. The pack did not fail during 5 min flow at maximum flow rate, 10.1 L/min. The failure rate of pure sand was found 0.5-0.8 L/min. The sand pack was significantly reinforced by the epoxy particles additive.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. A fluid composition comprising:
solid epoxy particles;
epoxy resin curing agent;
proppant; and
well-bore fluid,
wherein the solid epoxy particles together with the curing agent have a cure temperature in a range from 50° C. to 200° C.

2. The fluid composition according to claim 1, wherein the average particle size of the solid epoxy particles is less than the average size of the proppant.

3-5. (canceled)

6. The fluid composition according to claim 1, wherein the solid epoxy particles comprise at least one epoxy resin selected from the group consisting of diglycidyl ethers of bisphenol A, diglycidyl ethers of bisphenol F, novolak epoxy, and combinations thereof.

7. The fluid composition according to claim 1, comprising, by weight, 0.5 to 10 percent of the solid epoxy particles, 35 to 50 percent of the proppant, and 40 to 65 percent of the well-bore fluid, based on the total weight of the fluid composition.

8-10. (canceled)

11. The fluid composition according to claim 1, wherein the solid epoxy particles have at least one softening point in a range from 50° C. to 200° C., and a curing agent.

12-13. (canceled)

14. The fluid composition according to claim 1, wherein at least some of the solid epoxy particles comprise at least two different epoxy resins.

15. The fluid composition according to claim 1, wherein the epoxy resin curing agent includes at least two different epoxy resin curing agents.

16. The fluid composition according to claim 1, wherein at least some of the curing agent is present in at least some of the solid epoxy particles.

17. The fluid composition according to claim 1, wherein at least a portion of the solid epoxy particles and curing agent are present in a composite.

18. The fluid composition according to claim 17, wherein at least a portion of the composite is in the form of at least one of ribbon, flake, or powder.

19. The fluid composition according to claim 1, wherein the fluid composition further comprises at least one of a breaker chemical, a rheological modifier, a fiber, a tackifier, or a surfactant.

20-21. (canceled)

22. The fluid composition according to claim 1, wherein a portion of the solid epoxy particles are adhered to at least some of the proppant particles.

23. The fluid composition according to claim 1, wherein at least some of the epoxy resin curing agent is latent curing agent.

24. (canceled)

25. A method of making the fluid composition according to claim 1, the method comprising:
combining at least:
solid epoxy particles dispersed in a fluid;
epoxy resin curing agent;
proppant; and
well-bore fluid.

26. A method of making the fluid composition according to claim 1, the method comprising:
combining at least:
solid epoxy particles dispersed in a fluid, the dispersion
further comprising the curing agent;
proppant; and
well-bore fluid.

27. (canceled)

28. The method according to claim 31, where at least one of the epoxy resin and the curing agent is added via an additive system

29-30. (canceled)

31. A method of treating a subterranean formation, the method comprising:
deploying into a wellbore a fluid composition comprising solid epoxy particles; epoxy resin curing agent; proppant; and well-bore fluid, such that at least a portion of the fluid composition is in contact with at least one surface of the subterranean formation.

32-35. (canceled)

36. The method according to claim 31, wherein the subterranean formation has a temperature, the method further comprising making the fluid composition by at least:
determining the temperature of the subterranean formation;
generating, based at least in part on the determined temperature of the subterranean formation, a fluid composition design, wherein the designed fluid composition comprises the solid epoxy particles, the epoxy resin curing agent, the proppant, and the well-bore fluid, the solid epoxy particles having at least one softening point less than the temperature of the subterranean formation, and the solid epoxy particles together with the curing agent having a cure temperature less than the temperature of the subterranean formation; and
making the designed fluid composition.

37. A method of propping open fractures in the walls of a bored well, the method comprising:
deploying the fluid composition according to claim 1, wherein the well-bore fluid comprises fracturing fluid, into a into a wellbore at a pressure sufficient to create fractures in a subterranean formation, wherein the fracturing fluid flows into the fractures, and wherein at least the epoxy resin and proppant prop open at least some of the fractures.

38. A method of making a fluid composition, the method comprising:
selecting a subterranean formation having a temperature;
determining the temperature of the subterranean formation;
generating, based at least in part on the determined temperature of the subterranean formation, a fluid composition design, wherein the design fluid composition comprises solid epoxy particles, epoxy resin curing agent, proppant, and well-bore fluid, the solid epoxy particles having at least one softening point less than the temperature of the subterranean formation, and the solid epoxy particles together with the curing agent having a cure temperature less than the temperature of the subterranean formation; and
making the designed fluid composition.
